(19) United States
(12) Patent Application Publication
(10) Pub. No.: US 2025/0382551 A1
(43) Pub. Date: Dec. 18, 2025

(54) HYDROTROPIC SURFACE CLEANER AND METHOD FOR USE THEREOF

(71) Applicant: Illinois Tool Works Inc., Glenview, IL (US)

(72) Inventors: Chi Quang Nguyen, Glenview, IL (US); John Isidoro Escoto, JR., Glenview, IL (US)

(73) Assignee: Illinois Tool Works Inc., Glenview, IL (US)

(21) Appl. No.: 19/231,667

(22) Filed: Jun. 9, 2025

Related U.S. Application Data
(60) Provisional application No. 63/659,005, filed on Jun. 12, 2024.

(51) Int. Cl. C11D 1/83; B08B 3/08; C11D 1/22; C11D 1/72; C11D 3/20; C11D 3/34; C11D 3/43; C11D 3/50; C11D 17/00

(52) U.S. Cl. CPC C11D 1/83; B08B 3/08; C11D 3/2044; C11D 3/2068; C11D 3/2093; C11D 3/3463; C11D 3/43; C11D 3/50; C11D 17/0021; C11D 1/22; C11D 1/72

(57) ABSTRACT

A hydrotropic composition is provided for surface cleaning that includes at least two hydrotropic compounds, an anionic surfactant, a nonionic surfactant, at least one cosolvent having a partition coefficient of log Kow of greater than 1. Water is present as the majority by weight of the hydrotropic composition and forming an emulsion. The hydrotropic composition may be formulated for use in a trigger bottle, aerosol, or wipe applications. A method of lifting stains with the composition is provided.

### RELATED APPLICATIONS

This application is a non-provisional application that claims priority benefit of U.S. Provisional Application Ser. No. 63/659,005, filed Jun. 12, 2024; the contents of which are hereby incorporated by reference.

### FIELD OF THE INVENTION

The present invention in general relates to hydrotropic surface cleaner compositions and the use thereof, and in particular, to a composition able to remove sunblock stains from vehicle interior hard surfaces.

### BACKGROUND OF THE INVENTION

Surface cleaners are a category of cleaning agents of mainly aqueous solutions of specialty chemicals that vary with the amount of dirt and the surface being cleaned. All-purpose cleaners are typically concentrated solutions of surfactants and water softeners, which enhance the behavior of surfactant in hard water. Surfactants are compounds that lower the surface tension (or interfacial tension) between two liquids, between a gas and a liquid, or between a liquid and a solid. Surfactants may act as detergents, wetting agents, emulsifiers, foaming agents, and dispersants. In solution, detergents help solubilize a variety of chemical species by dissociating aggregates and unfolding proteins.

Unfortunately, some stains on surfaces are highly lipophilic and cannot be solubilized into a surfactant micelle under typical residence times for aqueous surfactants composition, regardless of whether such surfactants are present as a solution or an oil in water emulsion. This is especially true when the surface is not horizontal and any composition forms a thinner film on the surface that is more prone to evaporation than the same composition on a horizontal surface. Exemplary of such surfaces are those found in a vehicle interior, such as a dashboard, console, leather/faux leather, fabric, and elastomers. Lipophilic substances such as sunscreen not only readily penetrate vehicle interior surfaces but overtime can react with the surface. There are currently no effective products commercialized in the market that can remove stains from sunscreen, tree sap, tree resin, road tar, grease, marker pens, and crayons.

Thus, there exists a need for a product that can remove such stains without damaging the underlying surface. There further exists a need for a hydrotropic composition and a method for use that can readily lift such strains without resort to micellar structures.

### SUMMARY OF THE INVENTION

A hydrotropic composition for surface cleaning is provided that includes an anionic surfactant, a nonionic surfactant, at least two hydrotropic compounds, at least one solvent having an air/water partition coefficient of less than 30, an emulsion stabilizing polymer, and water present as the majority by weight of the hydrotropic composition and forming an emulsion.

A method of removing a stain from a vehicle surface is also provided that includes the application of the hydrotropic composition to the surface. After sufficient time, the stain is solubilized by the composition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings wherein:

FIG. 1A is a photograph of a vehicle fabric surface with a sunscreen stain therein;

FIG. 1B is a photograph of the vehicle fabric surface of FIG. 1A after treatment with an inventive composition with the stain no longer visible;

FIG. 2A is a with a sunscreen stain therein; photograph of a vehicle interior hard surface;

FIG. 2B is a photograph of the vehicle interior hard surface if FIG. 2A after treatment with a conventional cleaner with the stain still being visible; and

FIG. 2C is a photograph of the vehicle interior hard surface if FIG. 2A after treatment with a conventional cleaner with the stain no longer being visible.

### DETAILED DESCRIPTION OF THE PREFERRED EMBODIMENTS

The present invention has utility as a hydrotropic composition well-suited for cleaning lipophilic stains from a variety of surfaces and is in particular those found in a vehicle interior. Surfaces cleaned by an inventive composition illustratively include leather, leatherette, fabric, dashboards, steering wheels, consoles, and vehicle interior trim. Exterior vehicle surfaces suitable for cleaning by an inventive composition include wheels, tires, convertible tops, painted surfaces, glass panes, headlight domes, and pickup boxes. Specific polymers, regardless of usage context from which strains are lifted by an inventive composition illustratively include polyvinyl chloride, acrylonitrile butadiene styrene, polystyrene, polyethylene, polycarbonate, polyurethane, and block co-polymers in which any of the aforementioned, individually, or in combination make up from than 50% of the co-polymer subunits. The present invention provides an aqueous composition capable of removing stains such as those associated with sunscreen: an attribute not associated with any commercial products. The inventive composition has performance characteristics that are surprisingly achieved by relying on hydrotropic properties, as opposed to mere surfactancy. Embodiments of the inventive composition may be formulated for use in a trigger bottle, aerosol, or wipe applications.

It is to be understood that in instances where a range of values are provided, for example with respect to a weight percentage range of a composition component, that the range is intended to encompass not only the end point values of the range but also intermediate values of the range as explicitly being included within the range and varying by the last significant figure of the numeral. By way of example, a recited range of from 1 to 4 is intended to include 1-2, 1-3, 2-4, 3-4, and 1-4.

Not intending to be limited to a particular theory, many lipophilic materials, such as sunscreen act as plasticizers for many of polymers routinely used in forming vehicles interiors and as a result the resulting stain penetrates beyond the surface and into volume of the polymer. As a result, a surfactant alone is incapable of penetrating to polymer to remove the stain molecules in a micelle; the present invention uses a hydrotropic co-solvent mixture with specific partition coefficients to solubilize the stain molecules which can then be lifted from the surface by the composition.

Hydrotropes are compounds that improve the solubility of surfactants and some organic solvents in water. Absent hydrotropes, inventive compositions would tend to appear cloudy, indicating component separation out. While sodium xylene sulfonate is a prototypical hydrotrope, alone it adds little cleaning efficiency. As a result, the present invention relies on a mixture of at least two hydrotropes and a co-solvent with poor miscibility with water absent the inclusion of the at least two hydrotropes.

As used herein, “hydrotrope” is defined as compound that solubilizes hydrophobic compounds in aqueous solutions by means other than micellar solubilization and includes a hydrophilic moiety and a hydrophobic moiety yet is too small to cause spontaneous self-aggregation.

Hydrotropes operative herein include: C₁-C₅ monohydric alcohols (such as ethanol and n-or i-propanol); C₂-C₆ diols (such as monopropylene glycol and dipropylene glycol); C₃-C₉ triols (such as glycerol); polyethylene glycols having a weight average molecular weight (Mw) ranging from about 200 to 600; C₁-C₃ alkanolamines such as mono-, di-and triethanolamines; and alkyl aryl sulfonates having up to 3 carbon atoms in the lower alkyl group (such as the sodium and potassium xylene, toluene, ethylbenzene and isopropyl benzene (cumene) sulfonates); C₄-C₂₄ iminodipropionates; and combinations thereof. In some inventive embodiments, one of the at least two hydrotropes is anionic hydrotrope. Exemplary anionic hydrotropes include sodium-, potassium-, and ammonium-xylene sulfonate; sodium-, potassium-and ammonium-toluene sulfonate, sodium-, potassium-, and ammonium-cumene sulfonate, and mixtures thereof, and related compounds, as disclosed in U.S. Pat. No. 3,915,903. The two or more hydrotropes are each present in an amount of 1 to 20 total weight percent with the proviso that the total weight percent of hydrotropes is between 3 and 35 total weight percent. The hydrotropes are selected to have a mol molecular ratio averaged partition coefficient between n-octanol/air as calculated based on the ratio: (n-octanol/air)/(water/air) at 20° C. of log K_{ow} of less than −1. The partition coefficient being determined by the methods detailed in Gargas M L et al. Partition Coefficients of Low-Molecular Weight Volatile Chemicals in Various Liquids and Tissues. Toxicol. Appl. Pharmacol. 1989;98:87-99. By way of example the partition coefficients, log K_{ow} of sodium xyelene sulfonate and glycerol are −3.12 and −1.75, respectively.

In a specific composition according to the present invention, hydrotropes are added to assure the aqueous composition cloud point is above 35° C.

An anionic surfactant is also present in an inventive composition and illustratively includes sulfonates, sulfates, and carboxylates. Sulfonate anionic surfactants operative herein include C₉-C₁₅ alkylbenzenesulfonates; mixtures of alkene-and hydroxyalkane-sulfonates; and disulfonates such as those obtained by sulfonating mono-olefins and subsequent hydrolysis of the sulfonate group; alkanesulfonates; esters of α-sulfofatty acids, for example the α-sulfonic acids of hydrogenated methyl or ethyl esters of coconut oil, palm kernel oil or tallow fatty acid; and combinations thereof.

Suitable surfactants of the sulfate type include the sulfuric acid monoesters of primary alcohols, for example of coconut oil fatty alcohols, tallow fatty alcohols or oleyl alcohol, and those of secondary alcohols. Other suitable surfactants of the sulfate type include sulfatized fatty acid alkanolamides, fatty acid monoglycerides or reaction products of 1 to 4 mol of ethylene oxide with primary or secondary fatty alcohols or alkylphenols. Sulfated ethoxylates operative herein illustratively as anionic surfactants include sulfated nonyl phenol ethoxylates, alcohol ethoxysulfate salts, sodium N-methyl-N-oleoyltaurate, and sodium N-methyl-N-tall oil acid taurate. Other suitable anionic surfactants include the fatty acid esters or amides of hydroxycarboxylic or aminocarboxylic or sulfonic acid, such as for example fatty acid sarcosides, glycolates, lactates, taurides or isethionates, a-sulfosuccinic acid esters and fatty acid cyanamides.

The hydrophobic radicals of the surfactants generally contain between 6 and 18 and preferably between 8 to 18 carbon atoms.

The anionic surfactants may be present in the form of their alkali metal, alkaline-earth and ammonium salts and as soluble salts of organic bases, for example of mono-,di-or triethanolamine. An anionic surfactant is included in amounts of up to 5 total weight percent and in other embodiments from 0.1 to 3 total percent.

A nonionic surfactant is also present in an inventive composition and illustratively includes: ethoxylated fluorinated surfactants, polyether modified polydimethylsiloxane, polyether modified polymethylalkylsiloxane, aralkyl modified polymethylalkylsiloxane, polyester modified hydroxyl functional polydimethylsiloxane, acryl functional polyester modified polydimethylsiloxane, polyether polyester modified hydroxyl functional polydimethylsiloxane, solution of polyacrylate, solution of a fluoro modified polyacrylate, polymeric fluorinated, ethoxylated alcohol, ethoxylated fatty acid, sorbitan ester, ethoxylated castor oils, alkyl polysaccharides, sorbitan monostearate, sorbitan monolaurate, sorbitan oleate, polyoxyethylene sorbitan, polyoxyethylene sorbitan fatty acid ester, polyoxyethylene sorbitan monooleate surfactants; or anionic phosphonated fluorinated, phosphate ester, aliphatic phosphate ester; or cationic ethoxylated fatty ammonium ethosulphate, ethoxylated alkyl amine surfactants. The nonionic surfactant or combination thereof is selected such that the mol molecular amount averaged hydrophilic-lipophilic balance (HLB) has an HLB value of 8 and 18, and in other embodiments between 12 and 16. A nonionic surfactant is included in amounts of up to 5 total weight percent and in other embodiments from 0.05 to 3 total percent.

A co-solvent is critically provided that absent the inclusion of the at least two hydrotropes has poor water miscibility, as measured by a partition coefficient n-octonal/water of log K_{ow} of more than 1 or a mol molecular ratio averaged. log K_{ow} of more than 1 when two or more co-solvents are present. The improvement in miscibility is determined by an enhancement factor, which is the ratio of value in presence and absence of a hydrotrope. The enhancement factor is determined as detailed in Dharmendira Kumar, M. et anon. Effect of Hydrotropes on Solubility and Mass Transfer Coefficient of Amyl Acetate. Bioprocess Engineering 23, 31-36 (2000). Specific co-solvents operative herein illustratively include amyl acetate, C₃, C₄, and C₆-C₈ acetate esters, di(C₂-C₃ alkylene) glycol mono (C₁-C₄) ether, or combinations thereof. In some inventive embodiments, the co-solvent has, or the combination of solvents have a mol molecular ratio averaged HLB of between 10 and 14. A co-solvent or combination of co-solvents are included in amounts of up to 10 total weight percent and in other embodiments from 1 to 8 total percent.

An inventive composition forms an oil-in-water emulsion or microemulsion. In some inventive embodiments, an emulsion stabilizer is present. Emulsion stabilizers operative herein illustratively include an acrylic copolymer having a weight average molecular weight of 300 to 5,000; a polyester/acrylic copolymer, a carbomer, or a combination thereof. An emulsion stabilizer is included in amounts of up to 2 total weight percent and in other embodiments from 0.05 to 1 total percent.

As used herein, an “emulsion” is defined as a stable dispersion of immiscible liquids, that is not thermodynamically stable as kinetically is segregate with time. In contrast, as used herein, a “microemulsion” is an emulsion that is also thermodynamically stable.

A fragrance, pH neutralizing agent, or other ancillary additives are each independently present in some inventive compositions. A fragrance, if present, is included in amounts of up to 5 total weight percent and in other embodiments from 0.1 to 3 total percent. A PH neutralizing agent illustratively includes an inorganic-carbonate, -hydroxide, or combinations thereof. A pH neutralizing agent, if present, is included in amounts of up to 2 total weight percent and in other embodiments from 0.1 to 1 total percent.

In some inventive embodiments, the composition has a volatile organic compounds (VOC) content of from 0 to 3 total weight percent. It is appreciated that VOC content, if any, is often associated with the co-solvent. VOC as used herein is defined by Code of Federal Regulations, 40: Chapter 1, Subchapter C, Part 51, Subpart F, 51100.

An inventive composition is readily applied through resort to a conventional trigger spray application, propellant aerosol, or a sponge or cloth for wipe application onto the surface to be cleaned.

An inventive odor remover and surface cleaning composition has a fully formulated viscosity of between 5 and 400 cSt, as measured at room temperature.

Typical and preferred compositions according to the present invention are provided in Table 1.

Table 1. Inventive Surface Cleaning Composition (amounts in total weight percent)

| Ingredient | Typical | Preferred, if present |
|---|---|---|
| At least two hydrotropes | @ 1-20 | 3-35 total |
| Anionic surfactant | ≤5 | 0.1-3 |
| Nonionic surfactant | ≤5 | 0.05-3 |
| Cosolvent | ≤10 | 1-8 |
| Emulsion stabilizer | ≤2 | 0.01-1 |
| Fragrance | 0-5 | 0.1-3 |
| pH neutralizer | ≤2 | 0.1-1 |
| Water | to 100% | to 100% |

The present invention is further detailed with respect to the following nonlimiting examples that are provided to further illustrate the preparation of inventive compositions and certain attributes associated with the resulting coatings on tire surfaces.

### EXAMPLES

### Example 1

The following compositions form a cleaning product well suited for removal of sunscreen stains containing oxybenzone in a cream base. The fully solvated compositions are clear solutions at 20° C. under air and storage stable for at least three months.

### Inventive Composition 1

| Component | Total Weight Percent (%) |
|---|---|
| Isolaureth-6 | 0.90% |
| (Nonionic surfactant) | |
| Sodium Linear | 1.00% |
| Alkylbenzene Sulfonate, | |
| (Anionic surfactant) | |
| Sodium xylene | 1.50% |
| sulfonate (hydrotrope) | |
| Glycerol (hydrotrope) | 10.00% |
| Dipropylene glycol n- | 2.00% |
| butyl ether (hydrotrope) | |
| Amyl Acetate (cosolvent) | 2.95% |
| Acrylic Copolymer | 0.20% |
| (Emulsion stabilizer) | |
| Water | remainder |

### Examples 2-7

The following formulas are prepared relative to Example 1

| Example | modification relative to Example 1 |
|---|---|
| 2 | Dipropylene glycol n-butyl ether excluded and |
| | sodium xylene sulfonate increased to 3.5% |
| 3 | Amyl acetate replaced by like amount of C3-C8 |
| | acetate ester mixture |
| 4 | 2x amount of Amyl acetate and 2x amount of |
| | sodium xylene sulfonate with like amount |
| | reduction in water context |
| 5 | Isolaureth-6 replaced by 2x amount of alcohols, C- |
| | 9-11, ethoxylated, 2.5-8 EO mole mixture |
| | 2x amount of Amyl acetate and 2x amount of |
| | sodium xylene sulfonate with like amount |
| | reduction in water context |
| 6 | Dipropylene glycol n-butyl ether replaced by like |
| | amount of Dipropylene glycol methyl ether |
| 7 | Dipropylene glycol n-butyl ether replaced by like |
| | amount of Diethylene glycol n-butyl ether |

### Example 8

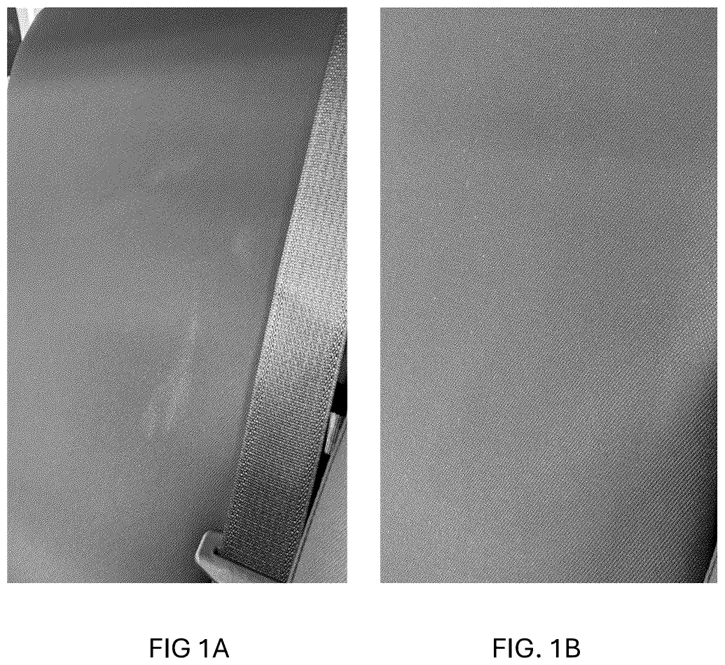

The composition of Example 1 is applied directly to a soiled surface with a dwell time of one minute before gently wiping the composition to lift the stain. The composition of Example 1 lifts a sunscreen stain from vehicle fabric as shown before, FIG. 1A and after FIG. 1B. No strain residue is noticeable to an unaided, normal human eye under room lighting conditions. The stains are baked at 120° F. for 3 hours and allowed to sit for 30 minutes at room temperature before the composition of Example 1 is applied.

### Example 9 and Comparative Example

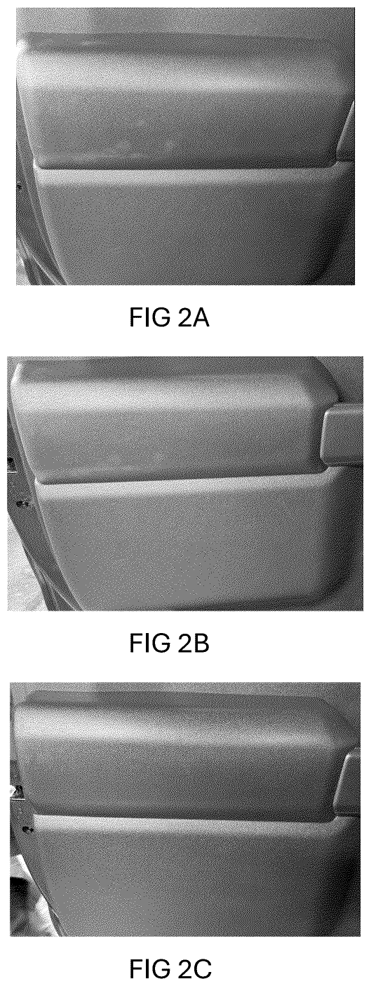

A vehicle interior surface stained with sunscreen (FIG. 2A) is exposed to the composition of Example 1 as detailed in Example 8. The stain is effectively lifted as shown in FIG. 2C. By way of comparison the application process is repeated with a Comparative Example composed of alcohol ethoxylates, glycol ether, isopropanol, water, and preservative. As shown in FIG. 2B, the Comparative Example composition fails to remove the like stain.

### Example 10

The procedure of Example 8 is repeated separately with faux leather, leather, interior console surface, an exterior painted class A surface, and headlight transparent plastic separately using the compositions of Examples 2-7. Stain removal is observed in all instances.

### Example 11

The procedures of Example 10 is repeated with each of road tar, tree sap, crayon with each of the compositions of Examples 1-7. Stain removal is observed in all instances.

Patents and publications mention the specification are indicative of the levels of those skilled in the art to which the invention pertains. These patents and publications are incorporated herein by reference to the same extent as if each individual patent or publication was specifically and individually incorporated herein by reference.

The forgoing description is illustrative of particular embodiments of the invention but is not meant to be a limitation upon the practice thereof. The following claims, including all equivalents thereof are intended to define the scope of the invention.

1. A hydrotropic composition for surface cleaning comprising:
at least two hydrotropic compounds;
an anionic surfactant;
a nonionic surfactant;
at least one cosolvent having a partition coefficient of log K_{ow} of greater than 1; and
water present as the majority by weight of the hydrotropic composition and forming an emulsion.

2. The hydrotropic composition of claim 1 wherein the nonionic surfactant comprises at least one of: sorbitan esters and ethoxylated sorbitan esters, ethoxylates, ethoxylated adducts, polyethylene glycol esters, propoxylates, ethoxylated modified triglycerides, alkylphenol aromatic ethoxylates, alkoxylated glycols having ethoxylated and propoxylated block segments, and silicone polyethers.

3. The hydrotropic composition of claim 1 wherein said anionic surfactant is present in a weight ratio to said nonionic surfactant of between 0.33-3:1.

4. The hydrotropic composition of claim 1 wherein said anionic surfactant is from 0.1 to 5 total weight percent of the hydrotropic composition.

5. The hydrotropic composition of claim 1 wherein said nonionic surfactant is from 0.1 to 5 total weight percent of the hydrotropic composition.

6. The hydrotropic composition of claim 1 wherein said nonionic surfactant has an HLB value of from 8 to 16.

7. The hydrotropic composition of claim 1 wherein said at least two hydrotropic compounds are present from 3 to 35 total weight percent of the hydrotropic composition.

8. The hydrotropic composition of claim 1 wherein said at least two hydrotropic compounds are xylene sulfonate, glycerol, dipropylene glycol n-butyl ether, tosylate, cumene sulfonate, salicylate, benzoate, nicotinamide, citrate, acetate, and combinations thereof.

9. The hydrotropic composition of claim 1 wherein said at least one solvent is C₃-C₆ alkyl acetate, or a combination thereof.

10. The hydrotropic composition of claim 1 wherein said at least one solvent is amyl acetate.

11. The hydrotropic composition of claim 1 wherein said at least one solvent is present from 1 to 12 total weight percent.

12. The hydrotropic composition of claim 1 further comprising a fragrance.

13. The hydrotropic composition of claim 1 wherein said fragrance is present from 0.05 to 1 total weight percent of the hydrotropic composition.

14. The hydrotropic composition of claim 1 wherein said emulsion is a microemulsion.

15. The hydrotropic composition of claim 1 further comprising an emulsion stabilizer.

16. The hydrotropic composition of claim 1 wherein amyl acetate is present from 1 to 5 total weight percent, glycerol is present from 0.5 to 6 total weight percent, and glycol ether is present from 1 to 8 total weight percent.

17. The hydrotropic composition of claim 1 wherein the volatile organic compound content is less than 3 total weight percent.

18. A method of removing a stain from a vehicle surface comprising:
applying the hydrotropic composition of claim 1 to the surface; and
allowing sufficient time for the stain to be solubilized by the composition.

19. The method of claim 18 further comprising wiping excess of the hydrotropic composition from the surface to effect cleaning of the surface.

20. The method of claim 18 wherein the applying is by a technique from among trigger spray application, propellant aerosol application, sponge application, or cloth application.
